(19) United States
(12) Patent Application Publication
(10) Pub. No.: US 2026/0250559 A1
(43) Pub. Date: Aug. 27, 2026

(54) RETROREFLECTIVE SHEET, ADHESIVE COMPOSITION, AND OVER-LAMINATE FILM

(71) Applicant: 3M INNOVATIVE PROPERTIES COMPANY, St. Paul, MN (US)

(72) Inventors: Shimpei Kudo, Midori-ku, Sagamihara-shi (JP); Yoshinori Araki, Sagae-shi (JP)

(21) Appl. No.: 19/160,142

(22) PCT Filed: Mar. 22, 2024
(86) PCT No.: PCT/IB2024/052786

§ 371 Date: Aug. 27, 2025

(30) Foreign Application Priority Data
Mar. 29, 2023 (JP) 2023-053449

(51) Int. Cl. C09J 7/38; B32B 7/06; B32B 7/12; C09J 7/29; C09J 11/04

(52) U.S. Cl. CPC C09J 7/385; B32B 7/06; B32B 7/12; C09J 7/29; C09J 11/04; B32B 2264/1024; B32B 2307/416; B32B 2405/00; C09J 2301/408; C09J 2301/414

(57) ABSTRACT

A retroreflective sheet having improved retroreflectivity, an adhesive composition and an over-laminate film usable for the retroreflective sheet. The retroreflective sheet includes at least a printed layer and an adjacent layer in contact with the printed layer. The adjacent layer contains an acrylic resin having a constituent unit derived from an ester of (meth)acrylic acid and an ethoxylated alkyl alcohol, and inorganic nanoparticles. The adjacent layer has a refractive index from 1.50 to 1.55.

### TECHNICAL FIELD

The present invention relates to a retroreflective sheet, an adhesive composition, and an over-laminate film.

### BACKGROUND ART

A retroreflective sheet that reflects incident light directly toward a light source, that is, has retroreflectivity, is widely used in road signs, guide display boards, and the like because high visibility can be obtained even at night.

The retroreflective sheet usually includes a retroreflective layer for imparting retroreflectivity, a printed layer for displaying necessary information, and a protective layer (adjacent layer) for protecting the printed layer. Among them, silk screen printing is generally applied to form the printed layer.

In this silk screen printing, printing is performed after preparing printing plates for different colors, and the silk screen printing is thus suitable for producing a large number of identical printed matters, but is not suitable for producing various kinds of printed matters in a small amount. In contrast, for example, Patent Document 1 proposes a method of forming a printed layer of a retroreflective sheet by inkjet printing capable of on-demand printing.

### CITATION LIST

### Patent Literature

Patent Document 1: WO 2013/145946

### Technical Problem

As a result of studies by the present inventors, it has been clarified that a retroreflective sheet having a printed layer formed by inkjet printing has room for improvement in retroreflectivity as compared to a retroreflective sheet having a printed layer formed by silk screen printing.

Accordingly, the present disclosure is directed to providing a retroreflective sheet having improved retroreflectivity, and an adhesive composition and an over-laminate film that can be used for the retroreflective sheet.

### Solution to Problem

One aspect of the present disclosure relates to a retroreflective sheet including a plurality of layers, the retroreflective sheet including at least a printed layer and an adjacent layer in contact with the printed layer, in which the adjacent layer contains an acrylic resin having a constituent unit derived from an ester of (meth)acrylic acid and an ethoxylated alkyl alcohol, and inorganic nanoparticles, and the adjacent layer has a refractive index from 1.50 to 1.55.

Such a retroreflective sheet is excellent in retroreflectivity even when the printed layer is formed by inkjet printing. In addition, such a retroreflective sheet is excellent in durability, weather resistance, and the like.

In the retroreflective sheet, the adjacent layer may be an adhesive layer, and the retroreflective sheet may include a retroreflective layer, the printed layer, the adhesive layer, and a protective film layer in this order.

The ester of (meth)acrylic acid and an ethoxylated alkyl alcohol may be 2-(2-ethoxyethoxy) ethyl acrylate or poly(ethylene glycol) methyl ether acrylate. This further improves dispersibility of inorganic nanoparticles in the adjacent layer, which makes it easier to adjust the refractive index.

The inorganic nanoparticles may be zirconia particles. This further improves dispersibility of inorganic nanoparticles in the adjacent layer, which makes it easier to adjust the refractive index.

Another aspect of the present disclosure relates to an adhesive composition containing an acrylic resin having a constituent unit derived from an ester of (meth)acrylic acid and an ethoxylated alkyl alcohol, and inorganic nanoparticles.

Such an adhesive composition can be suitably used for the retroreflective sheet. Furthermore, according to such an adhesive composition, it is possible to adjust the refractive index depending on the application.

Still another aspect of the present disclosure relates to an over-laminate film including a transparent substrate layer and an adhesive layer, in which the adhesive layer contains an acrylic resin having a constituent unit derived from an ester of (meth)acrylic acid and an ethoxylated alkyl alcohol, and inorganic nanoparticles.

Such an over-laminate film can be suitably used for the retroreflective sheet. Furthermore, according to such an over-laminate film, it is possible to adjust the refractive index depending on the application.

### Advantageous Effects of Invention

The retroreflective sheet of the present disclosure is excellent in retroreflectivity even when the printed layer is formed by inkjet printing. In addition, the retroreflective sheet of the present disclosure is excellent in durability, weather resistance, and the like.

The adhesive composition and the over-laminate film of the present disclosure can be used for the retroreflective sheet. In addition, according to the adhesive composition and the over-laminate film of the present disclosure, it is possible to adjust the refractive index depending on the application.

### BRIEF DESCRIPTION OF THE DRAWING

FIG. 1 is a schematic sectional view which shows one example of the retroreflective sheet of the present embodiment.

### DESCRIPTION OF EMBODIMENTS

An embodiment of the present disclosure will be described in detail below. In addition, a part of the drawing is exaggerated for ease of understanding, and the dimensional ratio is not limited to what is described in the drawing.

### Retroreflective Sheet

A retroreflective sheet of the present embodiment includes a plurality of layers including at least a printed layer and an adjacent layer in contact with the printed layer. The retroreflective sheet of the present embodiment may include a retroreflective layer, a printed layer, an adhesive layer, and a protective film in this order. The adjacent layer may be an adhesive layer. The layers will be described in detail below.

### Retroreflective Layer

As the retroreflective layer, there can be used a sheet, a film, or the like having such an attribute that incident light in an oblique direction is reflected in a direction antiparallel or substantially antiparallel to the incident direction to be returned to the light source or its vicinity, that is, retroreflectivity. The retroreflective layer may be beaded or prismatic as known in the related art.

Many films commonly used in signage applications can be used as the retroreflective layer. Specific examples thereof include a printing prism sheet sold under the trade name of “3M™ Diamond Grade™ DG3 Ultra-high Brightness Reflective Sheeting Wide-Angle Prism Type (Full Cube)” by 3M Japan Limited.

### Printed Layer

The printed layer can be formed on the retroreflective layer by printing a colorant such as ink or toner using a printing technique such as gravure printing, silk screen printing, offset printing, electrostatic printing, inkjet printing, or heat transfer printing. Among them, from the viewpoint of enabling on-demand printing, inkjet printing is preferable, and inkjet printing using a UV inkjet printer is more preferable.

The printed layer is preferably formed of an ultraviolet curable ink. The ultraviolet curable ink usually has a refractive index from 1.50 to 1.55 (particularly 1.51 to 1.54). As the ultraviolet curable ink, for example, inks of various colors (Blue, Black, Red, Yellow, Magenta, and Cyan) sold under a trade name of “3M™ Piezo Inkjet Series 8900UV Ink” by 3M Japan Limited can be used.

### Adjacent Layer (Adhesive Layer)

The adjacent layer is formed to be in contact with the printed layer. The adjacent layer may be an adhesive layer having adhesiveness.

The adjacent layer has a refractive index from 1.50 to 1.55. This makes it possible to improve the retroreflectivity of the retroreflective sheet even when the printed layer is formed by inkjet printing. The reason therefor is not necessarily clear, but the present inventors presume as follows.

In inkjet printing, printing is performed by directly spraying ink droplets. Thus, the printed layer formed by inkjet printing has unevenness due to the droplets on the surface. Here, when a difference in refractive index between the printed layer and the adjacent layer is relatively large, scattering of light due to the unevenness occurs at the interface between these layers, and thus the retroreflectivity is decreased. In contrast, it is considered that when the refractive index of the adjacent layer is set to from 1.50 to 1.55 to coincide with the refractive index of the ultraviolet curable ink forming the printed layer, scattering of light due to the unevenness can be suppressed, and the retroreflectivity is improved.

The difference between the refractive index of the adjacent layer and the refractive index of the printed layer is preferably 3.5% or less, more preferably 3% or less, and still more preferably 2.5% or less, from the viewpoint of further improving the retroreflectivity. Note that the difference between the refractive index of the adjacent layer and the refractive index of the printed layer is calculated by Equation (1) below.

$$\vert Refractive index of adjacent layer - refractive index of printed layer \vert / refractive index of adjacent layer \times 100 ( \% ) \qquad ( 1 )$$

Here, in a case where the printed layer is formed of a single ink, the difference between the refractive index of the adjacent layer and the refractive index of the ink is preferably within the above-described predetermined range. On the other hand, in a case where the printed layer is formed of a plurality of types of inks having different refractive indices, the difference between the refractive index of the adjacent layer and the refractive index of at least one type of ink is preferably within the above-described predetermined range, and the difference between the refractive index of the adjacent layer and the refractive index of each of the inks is more preferably within the above-described predetermined range.

The adjacent layer contains an acrylic resin having a constituent unit derived from an ester of (meth)acrylic acid and an ethoxylated alkyl alcohol, and inorganic nanoparticles. The acrylic resin is preferable in that the inorganic nanoparticles can be dispersed in the resin and the refractive index can be adjusted. In addition, the constituent unit in the acrylic resin has no hydroxyl group, and thus, it is possible to suppress corrosion and reaction with other materials that are caused by the presence of a hydroxyl group. Furthermore, the constituent unit in the acrylic resin has no aromatic ring, and thus, the retroreflective sheet is excellent in weather resistance.

The ethoxylated alkyl alcohol means an alcohol having a structure in which one or more ethylene oxides are added to an alkyl alcohol, that is, an alcohol having one or a plurality of consecutive oxyethylene groups between the alkyl group and the hydroxyl group in the alkyl alcohol.

The alkyl group in the alkyl alcohol may be, for example, an alkyl group having 1 to 10 carbon atoms, an alkyl group having from 1 to 5 carbon atoms, a methyl group or an ethyl group.

Specific examples of the ester of (meth)acrylic acid and an ethoxylated alkyl alcohol include methoxy (polyethylene glycol) (meth)acrylate, ethoxy (polyethylene glycol) (meth)acrylate, 2-(2-ethoxyethoxy) ethyl (meth)acrylate, ethylene glycol methyl ether (meth)acrylate, diethylene glycol methyl ether (meth)acrylate, triethylene glycol methyl ether (meth)acrylate, tetraethylene glycol methyl ether (meth)acrylate, ethylene glycol ethyl ether (meth)acrylate, diethylene glycol ethyl ether (meth)acrylate, triethylene glycol ethyl ether (meth)acrylate, tetraethylene glycol ethyl ether (meth)acrylate, and diethylene glycol-2-ethylhexyl ether (meth)acrylate. Among these, 2-(2-ethoxyethoxy)ethyl acrylate or poly(ethylene glycol) methyl ether acrylate is preferred. Note that the molecular weight of methoxy (polyethylene glycol) (meth)acrylate or ethoxy (polyethylene glycol) (meth)acrylate can be, for example, from 300 to 1000.

The acrylic resin may be composed only of a constituent unit derived from an ester of (meth)acrylic acid and an ethoxylated alkyl alcohol, or may include other constituent units as long as the effects of the invention are not impaired. Examples of monomers constituting the other constituent units include alkyl (meth)acrylate such as methyl (meth)acrylate, ethyl (meth)acrylate, n-propyl (meth)acrylate, n-butyl (meth)acrylate, n-pentyl (meth)acrylate, n-hexyl (meth)acrylate, 2-ethylhexyl (meth)acrylate, n-octyl (meth)acrylate, isooctyl (meth)acrylate, n-nonyl (meth)acrylate, isononyl (meth)acrylate, and n-decyl (meth)acrylate; and dicyclopentenyl (meth)acrylate, dicyclopentenyloxyethyl (meth)acrylate, tricyclo[5.2.1.0^{2.6}]decanyl (meth)acrylate, and glycidyl (meth)acrylate.

The acrylic resin can be obtained by polymerizing the ester of (meth)acrylic acid and an ethoxylated alkyl alcohol by a common radical polymerization method such as solution polymerization, suspension polymerization, emulsion polymerization, or bulk polymerization. As a polymerization initiator, an organic peroxide such as benzoyl peroxide, lauroyl peroxide, or bis(4-tert-butylcyclohexyl) peroxydicarbonate; or an azo-based polymerization initiator such as 2,2′-azobis(isobutyronitrile), 2,2′-azobis(2-methylbutyronitrile), dimethyl-2,2-azobis(2-methylpropionate), 4,4′-azobis(4-cyanovalerianic acid), dimethyl 2,2′-azobis(2-methylpropionate), or 2,2′-azobis(2,4-dimethylvaleronitrile) (AVN) can be used.

The inorganic nanoparticles are defined as particles having an average particle size of at least about 1, 2, 3, 4, 5, 6, 7, 8, 9, or even 10 nm, or at most about 15, 20, 25, 30, 35, 40, 45, or even 50 nm. Note that the average particle size can be measured using a dynamic light scattering method, for example. The inorganic nanoparticles may be discrete (i.e., non-aggregated) particles, aggregates of particles, or both.

The inorganic nanoparticles may include oxide nanoparticles. Examples of such oxides include silicon dioxide (silica), zirconia, titania, ceria, alumina, iron oxide, zinc oxide, vanadia, antimony oxide, tin oxide, and alumina/silica.

The inorganic nanoparticles may be in the form of colloidal dispersion. Examples of useful commercially available inorganic nanoparticles include a zirconia sol available under the trade name “NanoUse (trade name) OZ” (available from Nissan Chemical Corporation), a titania sol available under the trade name “NanoUse (trade name) OT” (available from Nissan Chemical Corporation), colloidal silica available under the trade name “NALCO COLLOIDAL SILICAS” (available from Nalco Chemical Company).

The adjacent layer can be formed using, for example, the following method. An acrylic resin solution is prepared by polymerizing an ester of (meth)acrylic acid and an ethoxylated alkyl alcohol, or the like, by solution polymerization. The inorganic nanoparticles are added to the acrylic resin solution to prepare a coating solution. The adjacent layer is formed by applying the coating solution onto a substrate and then heating and drying the coating solution. As the substrate, a protective film described below can be used.

The content of the inorganic nanoparticles in the adjacent layer can be appropriately adjusted in such a manner that the adjacent layer has a refractive index from 1.50 to 1.55, and, for example, is preferably from 25 to 55 mass %, and more preferably from 20 to 50 mass %, based on the amount of the entire adjacent layer.

### Protective Film Layer

As the protective film layer, a film commonly used for protection of an optical material can be used. As a material therefor, for example, an acrylic resin, a urethane resin, an epoxy resin, a polyvinyl chloride resin, a polyester resin, a fluororesin, or a mixture of these can be used. Among them, an acrylic resin or a mixture of a fluororesin and an acrylic resin is preferable, and polymethyl methacrylate (PMMA) or a mixture of polyvinylidene fluoride (PVDF) and polymethyl methacrylate (PMMA) is more preferable.

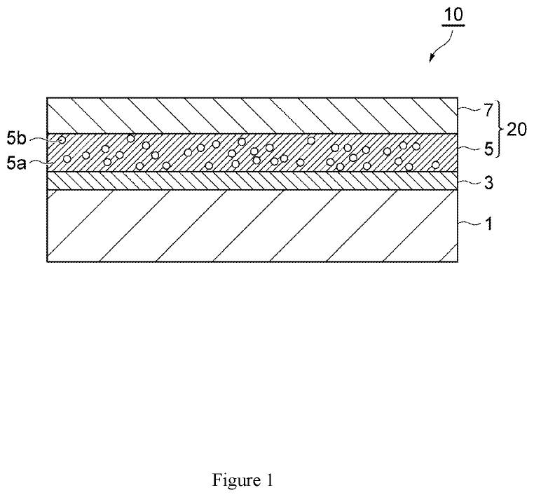

FIG. 1 is a schematic cross-sectional view showing an example of the retroreflective sheet of the present embodiment. The retroreflective sheet 10 of FIG. 1 has a structure in which a retroreflective layer 1, a printed layer 3, an adhesive layer (an adjacent layer) 5, and a protective film layer 7 are laminated in this order. The adhesive layer (adjacent layer) 5 is made of an acrylic resin 5a and inorganic nanoparticles 5b. Further, the laminate having the protective film layer (transparent substrate layer) 7 and the adhesive layer 5 corresponds to an over-laminate film 20 described later.

### Method for Producing Retroreflective Sheet

The method for producing a retroreflective sheet is not particularly limited, but the retroreflective sheet can be produced by, for example, the following method. First, a printed layer is formed on a retroreflective layer by inkjet printing. Separately, an adhesive layer containing the acrylic resin and the inorganic nanoparticles is formed on a protective film. The retroreflective layer on which the printed layer is formed and the protective film on which the adhesive layer is formed are bonded to each other in such a manner that the printed layer and the adhesive layer are in contact with each other, whereby a retroreflective sheet can be produced.

### Adhesive Composition

An adhesive composition of the present embodiment contains an acrylic resin having a constituent unit derived from an ester of (meth)acrylic acid and an ethoxylated alkyl alcohol, and inorganic nanoparticles. In general, a refractive index of an acrylic resin used in an adhesive is about 1.47, but according to the adhesive composition of the present embodiment, the refractive index of the entire adhesive composition can be adjusted by dispersing inorganic nanoparticles having a relatively high refractive index. In addition, the constituent unit in the acrylic resin has no hydroxyl group, and thus, it is possible to suppress corrosion and reaction with other materials that are caused by the presence of a hydroxyl group. Furthermore, the constituent unit in the acrylic resin has no aromatic ring, and thus, the adhesive composition is excellent in weather resistance.

The content of the inorganic nanoparticles in the adhesive composition can be appropriately adjusted depending on the required refractive index of the adhesive composition, and can be adjusted to, for example, from 10 to 90 mass % or from 20 to 80 mass %, based on the amount of the entire adhesive composition.

### Over-Laminate Film

An over-laminate film of the present embodiment is an over-laminate film including a transparent substrate layer and an adhesive layer, and the adhesive layer contains an acrylic resin having a constituent unit derived from an ester of (meth)acrylic acid and an ethoxylated alkyl alcohol, and inorganic nanoparticles. Such an over-laminate film can be suitably applied to surface protection of an optical material, and is excellent in that the refractive index can be adjusted because the above-described adhesive composition is used.

Note that in the adhesive composition and the over-laminate film, the acrylic resin and the inorganic nanoparticles may be the same as those described for the adjacent layer. As the transparent substrate layer, for example, the same protective film as described above can be employed. “Transparent” means that an average transmittance of visible light, that is, light in a wavelength range of 380 nm to 780 nm is approximately 60% or greater, preferably approximately 80% or greater, and more preferably approximately 90% or greater.

### EXAMPLES

The content of the present invention will be described in further detail below using examples and comparative examples, but the present invention is not limited to the following examples. The abbreviations, compound names, trade names, suppliers, and the like of the materials used in the examples and comparative examples are as follows.
EEEA: 2-(2-ethoxyethoxy)ethyl acrylate (ethyl carbitol acrylate) (trade name: Viscoat #190, available from OSAKA ORGANIC CHEMICAL INDUSTRY LTD.)
PEGME: poly(ethylene glycol) methyl ether acrylate (methoxy polyethylene glycol acrylate) (molecular weight: 620 g/mol, trade name: MPE550A, available from OSAKA ORGANIC CHEMICAL INDUSTRY LTD.)
AVN: 2,2′-azobis(2,4-dimethylvaleronitrile) (trade name: V-65, available from FUJIFILM Wako Pure Chemical Corporation)
Nanoparticle dispersion liquid: zirconia nanoparticle dispersion liquid (refractive index of particles: from 1.85 to 1.90, dispersion medium: methyl ethyl ketone, particle size: 10 to 30 nm (dispersed particle size by dynamic light scattering method), trade name: NanoUse OZ-S40K-AC, available from Nissan Chemical Corporation)
MEK: methyl ethyl ketone (available from Yamaichi Chemical Industries Co., Ltd.)
Ethyl acetate: ethyl acetate (available from FUJIFILM Wako Pure Chemical Corporation)

### Preparation of (Meth)Acrylic Polymer Solution A1

100 parts by mass of 2-(2-ethoxyethoxy)ethyl acrylate (EEEA) was dissolved in 45 parts by mass of methyl ethyl ketone (MEK) and 103 parts by mass of ethyl acetate, and 0.4 parts by mass of 2,2′-azobis(2,4-dimethylvaleronitrile) (AVN) was added thereto as a polymerization initiator. The mixture was then reacted at 50° C. for 24 hours under a nitrogen atmosphere, and a (meth)acrylic polymer solution A1 was prepared.

### Preparation of (Meth)Acrylic Polymer Solution A2

A (meth)acrylic polymer solution was prepared in the same manner as in the preparation of the (meth)acrylic polymer solution A1 described above. A nanoparticle dispersion liquid (available from Nissan Chemical Corporation, NanoUse OZ-S40K-AC, solid content 40 mass %) was added to the obtained (meth)acrylic polymer solution, and mixed and stirred so that the content of inorganic components was 10 mass %, and a (meth)acrylic polymer solution A2 was prepared.

### Preparation of (Meth)Acrylic Polymer Solution A3

A (meth)acrylic polymer solution A3 was prepared in the same manner as in the preparation of the (meth)acrylic polymer solution A2, except that adjustment was performed so that the content of inorganic components was 30 mass %.

### Preparation of (Meth)Acrylic Polymer Solution A4

A (meth)acrylic polymer solution A4 was prepared in the same manner as in the preparation of the (meth)acrylic polymer solution A2, except that adjustment was performed so that the content of inorganic components was 50 mass %.

### Preparation of (Meth)Acrylic Polymer Solution A5

A (meth)acrylic polymer solution A5 was prepared in the same manner as in the preparation of the (meth)acrylic polymer solution A2, except that adjustment was performed so that the content of inorganic components was 70 mass %.

### Preparation of (Meth)Acrylic Polymer Solution B1

100 parts by mass of poly(ethylene glycol) methyl ether acrylate (PEGME) was dissolved in 45 parts by mass of methyl ethyl ketone (MEK) and 103 parts by mass of ethyl acetate, and 0.4 parts by mass of 2,2′-azobis(2,4-dimethylvaleronitrile) (AVN) was added thereto as a polymerization initiator. The mixture was then reacted at 50° C. for 24 hours under a nitrogen atmosphere, and a (meth)acrylic polymer solution B1 was prepared.

### Preparation of (Meth)Acrylic Polymer Solution B2

A (meth)acrylic polymer solution was prepared in the same manner as in the preparation of the (meth)acrylic polymer solution B1 described above. A nanoparticle dispersion liquid (available from Nissan Chemical Corporation, NanoUse OZ-S40K-AC, solid content 40 mass %) was added to the obtained (meth)acrylic polymer solution, and mixed and stirred so that the content of inorganic components was 30 mass %, and a (meth)acrylic polymer solution B2 was prepared.

### Preparation of (Meth)Acrylic Polymer Solution B3

A (meth)acrylic polymer solution B3 was prepared in the same manner as in the preparation of the (meth)acrylic polymer solution B2, except that adjustment was performed so that the content of inorganic components was 50 mass %.

### Preparation of (Meth)Acrylic Polymer Solution C1

50 parts by mass of 2-ethylhexyl acrylate (2EHA) available from OSAKA ORGANIC CHEMICAL INDUSTRY LTD. and 50 parts by mass of butyl acrylate (BA) available from FUJIFILM Wako Pure Chemical Corporation were dissolved in 45 parts by mass of methyl ethyl ketone (MEK) and 103 parts by mass of ethyl acetate, and 0.4 parts by mass of 2,2′-azobis(2,4-dimethylvaleronitrile) (AVN) was added thereto as a polymerization initiator. The mixture was then reacted at 50° C. for 24 hours in a nitrogen atmosphere, and a (meth)acrylic polymer solution was prepared. A nanoparticle dispersion liquid (available from Nissan Chemical Corporation, NanoUse OZ-S40K-AC, solid content 40 mass %) was added to the obtained (meth)acrylic polymer solution, and mixed and stirred so that the content of inorganic components was 10 mass %, and a (meth)acrylic polymer solution C1 was prepared. The obtained (meth)acrylic polymer solution C1 became turbid and precipitates were formed, and thus, the following examination was not carried out.

### Preparation of (Meth)Acrylic Polymer Solution C2

90 parts by mass of 2-ethylhexyl acrylate (2EHA) available from OSAKA ORGANIC CHEMICAL INDUSTRY LTD. and 10 parts by mass of acrylic acid (AA) available from NIPPON SHOKUBAI Co., Ltd, were dissolved in 45 parts by mass of methyl ethyl ketone (MEK) and 103 parts by mass of ethyl acetate, and 0.4 parts by mass of 2,2′-azobis(2,4-dimethylvaleronitrile) (AVN) was added thereto as a polymerization initiator. The mixture was then reacted at 50° C. for 24 hours under a nitrogen atmosphere, and a (meth)acrylic polymer solution was prepared. A nanoparticle dispersion liquid (available from Nissan Chemical Corporation, NanoUse OZ-S40K-AC, solid content 40 mass %) was added to the obtained (meth)acrylic polymer solution, and mixed and stirred so that the content of inorganic components was 10 mass %, and a (meth)acrylic polymer solution C2 was prepared. The obtained (meth)acrylic polymer solution C2 became turbid and precipitates were formed, and thus, the following examination was not carried out.

### Production of Retroreflective Sheet A1

The (meth)acrylic polymer solution A1 was applied onto a polymethyl methacrylate (PMMA) film having a thickness of 75 μm using a knife coater to have a thickness of 40 μm after drying. After drying at 65° C. for 2 minutes and at 95° C. for 3 minutes, a PMMA over-laminate film with a (meth)acrylic adhesive was obtained.

Solid printing was performed on a surface of a printing prism sheet (manufactured and sold under the trade name “3M™ Diamond Grade™ DG3 Ultra-high Brightness Reflective Sheeting Wide-Angle Prism Type (Full Cube) DG4090”) by mounting inks (ink colors: yellow, white, magenta, cyan, and black) sold under the trade name “LUS-200” by MIMAKI ENGINEERING Co., Ltd. on a UV inkjet printer sold under the trade name “UJF-3042FX UV PRINTER” by MIMAKI ENGINEERING Co., Ltd. The printer was set to the following conditions: resolution [720×600 VD], other conditions [Pass8, Overprint 1 times], and print color setting [M100].

The resulting printing prism sheet with ink and the above-mentioned over-laminate film were bonded to each other using a hand squeeze roller in such a manner that the printed layer and the adhesive layer were in contact with each other, thereby obtaining a retroreflective sheet A1.

Note that the refractive index of the ink in the printed layer printed with the print color setting [M100] is 1.543.

### Production of Retroreflective Sheets A2 to A5 and B1 to B3

Retroreflective sheets A2 to A5 and B1 to B3 were obtained in the same manner as in the production of the retroreflective sheet A1, except that the (meth)acrylic polymer solutions A2 to A5 and B1 to B3 were used in place of the (meth)acrylic polymer solution A1.

### Production of Retroreflective Sheet C3

A retroreflective sheet C3 was obtained in the same manner as in the production of the retroreflective sheet A1, except that “3M™ ElectroCut™ Film ECF1170C” available from 3M Japan Limited was used as the PMMA over-laminate film with a (meth)acrylic adhesive.

### Evaluation of Retroreflective Sheet

For the retroreflective sheets A1 to A5, B1, B2, and C3 obtained above, coefficients of retroreflection, refractive indices of the adhesive layers, and contents of inorganic components were measured by the following methods. The results are shown in Table 1.

### Measurement of Coefficient of Retroreflection

A coefficient of retroreflection (cd/lx/m²) was obtained by measuring a coefficient of retroreflection at an observation angle of 0.2° and an incident angle of 5°, that is, 0.2°/5° using a retroreflection measuring device RetroSign GRX (available from DELTA). Specifically, the measurement was performed by making the handle of the measuring device parallel to and orthogonal to a sheet winding direction. The measurement was performed at appropriate three points from the produced reflective sheet, an average of parallel and orthogonal measured values was calculated to determine a coefficient of retroreflection of the reflective sheet.

### Measurement of Refractive Index

For the printed layer or the adhesive layer, Metricon Model 2010 Prism Coupler (available from Metricon Corporation) was used to measure a refractive index of light having a wavelength of 633 nm at room temperature.

### Measurement of Content of Inorganic Component

The obtained adhesive was heated at 600° C. for 10 minutes under air supply. The residue after heating was taken as inorganic components, and a value obtained by dividing the weight of the residue by the weight of the adhesive at the initial room temperature was taken as the content of inorganic components.

TABLE 1

| | | Content of | | |
|---|---|---|---|---|
| | | inorganic | Coefficient of | |
| Retroreflective | | components | retroreflection | Refractive |
| sheet | Monomers | (mass %) | (cd/lx/m²) | index |
| A1 | EEEA | 0 | 39 | 1.468 |
| A2 | EEEA | 10 | 48 | 1.478 |
| A3 | EEEA | 30 | 85 | 1.505 |
| A4 | EEEA | 50 | 163 | 1.542 |
| A5 | EEEA | 70 | 29 | 1.596 |
| B1 | PEGME | 0 | 40 | 1.472 |
| B2 | PEGME | 30 | 87 | 1.512 |
| B3 | PEGME | 50 | 150 | 1.550 |
| C3 | — | 0 | 43 | 1.471 |

### Preparation of (Meth)Acrylic Polymer Solution A6

100 parts by mass of 2-(2-ethoxyethoxy)ethyl acrylate (EEEA) was dissolved in 45 parts by mass of methyl ethyl ketone (MEK) and 103 parts by mass of ethyl acetate, and 0.4 parts by mass of 2,2′-azobis(2,4-dimethylvaleronitrile) (AVN) was added thereto as a polymerization initiator. The mixture was then reacted at 50° C. for 24 hours under a nitrogen atmosphere, and a (meth)acrylic polymer solution A6 was prepared.

### Preparation of (Meth)Acrylic Polymer Solution A7

A (meth)acrylic polymer solution was prepared in the same manner as in the preparation of the (meth)acrylic polymer solution A6. A nanoparticle dispersion liquid (available from Nissan Chemical Corporation, NanoUse OZ-S40K-AC, solid content 40 mass %) was added to the obtained (meth)acrylic polymer solution, and mixed and stirred so that the content of inorganic components was 20 mass %, and a (meth)acrylic polymer solution A7 was prepared.

### Preparation of (Meth)Acrylic Polymer Solution A8

A (meth)acrylic polymer solution A8 was prepared in the same manner as in the preparation of the (meth)acrylic polymer solution A6, except that adjustment was performed so that the content of inorganic components was 30 mass %.

### Preparation of (Meth)Acrylic Polymer Solution A9

A (meth)acrylic polymer solution A9 was prepared in the same manner as in the preparation of the (meth)acrylic polymer solution A6, except that adjustment was performed so that the content of inorganic components was 40 mass %.

### Preparation of (Meth)Acrylic Polymer Solution A10

A (meth)acrylic polymer solution A10 was prepared in the same manner as in the preparation of the (meth)acrylic polymer solution A6, except that adjustment was performed so that the content of inorganic components was 50 mass %.

### Preparation of (Meth)Acrylic Polymer Solution A11

A (meth)acrylic polymer solution A11 was prepared in the same manner as in the preparation of the (meth)acrylic polymer solution A6, except that adjustment was performed so that the content of inorganic components was 60 mass %.

### Production of Retroreflective Sheet A6

The (meth)acrylic polymer solution A6 was applied to a polymethyl methacrylate (PMMA) film having a thickness of 75 μm using a knife coater to have a thickness of 40 μm after drying. After drying at 65° C. for 2 minutes and at 95° C. for 3 minutes, a PMMA over-laminate film with a (meth)acrylic adhesive was obtained.

Solid printing was performed on a surface of a printing prism sheet (manufactured and sold under the trade name “3M™ Diamond Grade™ DG3 Ultra-high Brightness Reflective Sheeting Wide-Angle Prism Type (Full Cube) DG4090”) using a UV inkjet printer sold under the trade name “Rho 163 TS” by Durst Inc. The printer was set to the following conditions: resolution [600×600 dpi], other conditions [Pass 2], and print color setting [M100, Y100, and traffic color (Red, Yellow, Brown, Purple)]. As ink for printing, 3M™ Piezo Inkjet Series 8900UV Ink (ink colors: Blue, Black, Red, Yellow, Magenta, and Cyan) was used.

The resulting printing prism sheet with ink and the above-mentioned over-laminate film were bonded to each other using a hand squeeze roller in such a manner that the printed layer and the adhesive layer were in contact with each other, thereby obtaining a retroreflective sheet A6.

Note that the refractive indices of red and yellow output according to the traffic color setting of the UV inkjet printer are 1.519 and 1.532, respectively.

### Production of Retroreflective Sheets A7 to A11

Retroreflective sheets A7 to A11 were obtained in the same manner as in the production of the retroreflective sheet A6 described above, except that the (meth)acrylic polymer solutions A7 to A11 were used in place of the (meth)acrylic polymer solution A6.

### Production of Retroreflective Sheet C4

A retroreflective sheet C4 was obtained in the same manner as in the production of the retroreflective sheet A6, except that “3M™ ElectroCut™ Film ECF1170C” available from 3M Japan Limited was used as the PMMA over-laminate film with a (meth)acrylic adhesive.

### Evaluation of Retroreflective Sheet

For the retroreflective sheets A6 to A11 and C4 obtained as described above, coefficients of retroreflection, refractive indices of the adhesive layers, and contents of inorganic components were measured by the above-described methods. The results are shown in Table 2.

TABLE 2

| | | Content of | | | | | | |
|---|---|---|---|---|---|---|---|---|
| | | inorganic | | | | | | |
| Retroreflective | Refractive | components | Coefficient of retroreflection (cd/lx/m²) | | | | | |
| sheet | index | (mass %) | M100 | Y100 | Red | Yellow | Brown | Purple |
| A6 | 1.468 | 0 | 90 | 275 | 100 | 344 | 89 | 39 |
| A7 | 1.489 | 20 | 109 | 332 | 123 | 404 | 99 | 46 |
| A8 | 1.504 | 30 | 141 | 446 | 164 | 490 | 130 | 61 |
| A9 | 1.521 | 40 | 151 | 483 | 189 | 520 | 143 | 60 |
| A10 | 1.540 | 50 | 124 | 433 | 173 | 471 | 134 | 48 |
| A11 | 1.563 | 60 | 82 | 293 | 123 | 367 | 99 | 27 |
| C4 | 1.470 | 0 | 85 | 265 | 102 | 340 | 92 | 30 |

### Weathering Test

The retroreflective sheets A1 and A3 were subjected to a weathering test using JIS Z 9117:2011_8.5.1 Sunshine Carbon Arc Lamp Accelerated Weathering Test (SWOM). The results are shown in Table 3. Note that when ΔE is 5 or less, it is evaluated that yellowing is sufficiently suppressed and weather resistance is excellent.

TABLE 3

| Retroreflective | A1 | | | | A3 | | | |
|---|---|---|---|---|---|---|---|---|
| sheet | Y | x | .y | ΔE | Y | x | .y | ΔE |
| Initial | 8.214 | 0.422 | 0.209 | | 8.038 | 0.423 | 0.207 | |
| 500 hours | 8.241 | 0.422 | 0.212 | 1.596 | 8.187 | 0.421 | 0.208 | 0.651 |
| 1000 hours | 8.703 | 0.416 | 0.214 | 2.426 | 9.790 | 0.400 | 0.209 | 4.846 |

### EXPLANATION OF SIGNS

1 . . . Retroreflective layer, 3 . . . Printed layer, 5 . . . Adhesive layer (adjacent layer), 5a . . . Acrylic resin, 5b . . . Inorganic nanoparticles, 7 . . . Protective film layer (transparent substrate layer), 10 . . . . Retroreflective sheet, 20 . . . Over-laminate film.

1. A retroreflective sheet comprising a plurality of layers,
the retroreflective sheet comprising at least a printed layer and an adjacent layer in contact with the printed layer, wherein
the adjacent layer contains an acrylic resin having a constituent unit derived from an ester of (meth)acrylic acid and an ethoxylated alkyl alcohol, and inorganic nanoparticles, and
the adjacent layer has a refractive index from 1.50 to 1.55.

2. The retroreflective sheet according to claim 1, wherein the adjacent layer is an adhesive layer, and the retroreflective sheet includes a retroreflective layer, the printed layer, the adhesive layer, and a protective film layer in this order.

3. The retroreflective sheet according to claim 1, wherein the ester of (meth)acrylic acid and an ethoxylated alkyl alcohol is 2-(2-ethoxyethoxy)ethyl acrylate or poly(ethylene glycol) methyl ether acrylate.

4. The retroreflective sheet according to claim 1, wherein the inorganic nanoparticles are zirconia particles.

5. The retroreflective sheet according to claim 1, in which the printed layer is a printed layer formed by inkjet printing.

6. The retroreflective sheet according to claim 5, in which the inkjet printing is performed using a UV inkjet printer.

7. The retroreflective sheet according to claim 1, wherein the printed layer is formed of an ultraviolet curable ink.

8. An adhesive composition containing an acrylic resin having a constituent unit derived from an ester of (meth)acrylic acid and an ethoxylated alkyl alcohol, and inorganic nanoparticles.

9. The adhesive composition according to claim 8, in which the ester of (meth)acrylic acid and an ethoxylated alkyl alcohol is 2-(2-ethoxyethoxy)ethyl acrylate or poly(ethylene glycol) methyl ether acrylate.

10. The adhesive composition according to claim 8, in which the inorganic nanoparticles are zirconia particles.

11. An over-laminate film, comprising:
a transparent substrate layer; and
an adhesive layer,
wherein the adhesive layer contains an acrylic resin having a constituent unit derived from an ester of (meth)acrylic acid and an ethoxylated alkyl alcohol, and inorganic nanoparticles.

12. The over-laminate film according to claim 11, in which the ester of (meth)acrylic acid and an ethoxylated alkyl alcohol is 2-(2-ethoxyethoxy)ethyl acrylate or poly(ethylene glycol) methyl ether acrylate.

13. The over-laminate film according to claim 11, in which the inorganic nanoparticles are zirconia particles.
